(19) United States
(12) Patent Application Publication
(10) Pub. No.: US 2008/0005327 A1
(43) Pub. Date: Jan. 3, 2008

(54) Commodity trading computing resources

(76) Inventor: Kirk I. Hays, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/476,388

(22) Filed: Jun. 28, 2006

(51) Int. Cl. G06F 15/173

(52) U.S. Cl. 709/225

(57) ABSTRACT

The present disclosure relates to trading computing resources, and more specifically making a market in grid computing resources.

### BACKGROUND

1. Field

The present disclosure relates to trading computing resources, and more specifically making a market in grid computing resources.

2. Background Information

The modern commodity markets have their roots in the trading of agricultural products. While wheat and corn, cattle and pigs, were widely traded using standard instruments in the 19th century in the United States, other basic foodstuffs as soybeans were only added quite recently in most markets. The economic impact of the development of commodity markets is hard to over-estimate. Through the 19th century “the exchanges became effective spokesmen for, and innovators of, improvements in transportation, warehousing, and financing, which paved the way to expanded interstate and international trade.”

Historically, commodities were some physical substance such as food, grains, and metals, which are interchangeable with another product of the same type. The price of the commodity is subject to supply and demand and will fluctuate through time. As such, futures contracts may be bought and sold for the purchase or sale of a commodity at a future date for an agreed upon price.

Risk is often the rational behind futures trading. For example, a farmer faces the problem of having his wealth determined by a single (or nearly a single) crop, let us say wheat. The entire planting season's revenue depends upon the highly volatile crop price. The miller who must purchase the wheat for processing faces the mirror image of the farmer's problem. The miller's cost of production is entirely dependent on the highly volatile crop price.

Both parties would like to reduce the amount of risk they face due to the changing crop price. Therefore, they enter into a futures or forward contract to buy and sell the wheat to each other at a certain date for a certain price. No matter how much the price of wheat changes between the date of the contract and the date of sale the farmer and miller are guaranteed a fixed price for the wheat. The miller and the farmer have reduced their risk by converting a volatile price into a fixed known quantity. Also, typically in a futures contract no money changes hands for the commodity until the determined delivery date.

Grid computing is an emerging computing model that often provides the ability to perform higher throughput computing by taking advantage of many networked computers to model a virtual computer architecture that is able to distribute process execution across a parallel infrastructure. Grids typically use the resources of many separate computers connected by a network (usually the Internet) to solve large-scale computation problems. Grids frequently provide the ability to perform computations on large data sets, by breaking them down into many smaller ones, or provide the ability to perform many more computations at once than would be possible on a single computer, by modeling a parallel division of labour between processes.

Grid computing reflects a conceptual framework rather than a physical resource. One characteristic that currently distinguishes Grid computing from distributed computing is the abstraction of a ‘distributed resource’ into a Grid resource. One result of abstraction is that it allows resource substitution to be more easily accomplished. The resource is typically virtualized such that a process running on the grid, or part of the grid, may be moved to another grid without the problems typically associated with a non-virtual system.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a flow chart illustrating an embodiment of a technique to trade computing resources in accordance with the disclosed subject matter;

FIG. 2 is a diagram illustrating an embodiment of a technique to trade computing resources in accordance with the disclosed subject matter;

FIG. 3 is a diagram illustrating an embodiment of a technique to trade computing resources in accordance with the disclosed subject matter;

FIGS. 4A & 4B are diagrams illustrating an embodiment of a technique to trade computing resources in accordance with the disclosed subject matter;

FIGS. 5A & 5B are diagrams illustrating an embodiment of a technique to trade computing resources in accordance with the disclosed subject matter;

FIGS. 6A & 6B are diagrams illustrating an embodiment of a technique to trade computing resources in accordance with the disclosed subject matter;

FIGS. 7A & 7B are diagrams illustrating embodiments of techniques to trade computing resources in accordance with the disclosed subject matter;

FIG. 8 is a flow chart illustrating an embodiment of a technique to trade computing resources in accordance with the disclosed subject matter; and

FIG. 9 is a block diagram illustrating an embodiment of a system to trade computing resources in accordance with the disclosed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

The present disclosure relates to trading computing resources, and more specifically making a market in grid computing resources. In one embodiment, computing resources may be viewed as fungible assets in much the same way commodities are fungible assets. In one embodiment, the computing resources may be properly virtualized such that a resource provided by one computing system is essentially substitutable for another computing resource provided by a second computing system.

For example, if an application is designed to run under a virtual machine it would not matter if the host operating system was based upon Microsoft Windows, Apple Macintosh, a mainframe system or another operating system. Therefore, one could start the application running on a Windows host, pause the application, and move it to a mainframe system without any loss in capability. The same concept of abstraction or virtualization may be extended to other computing resources, such as, for example, processor architecture, memory size, etc. It is understood that this is merely one specific embodiment and is not limiting on the disclosed subject matter.

Typically large organizations may setup large computing systems. These computing systems may not be fully utilized. Often these periods of low utilization may be predicted. For example, many computing systems may be idle once the workforce has gone home for the day. In another example, the computing systems may be idle during non-peak shopping times.

Currently, unused computing cycles (as an example computing resource) go to waste. Most computers sit idle, most of the time. Conversely, organizations that cannot quickly acquire compute cycles to meet unexpected demand suffer delays and lost opportunities. Organizations that over provision, in anticipation of peak demand waste money owning and maintaining those computing resources. By selling off excess computing resources, and buying needed resources on an open market when needed, an organization could maximize the Return On Investment (ROI) on a compute grid.

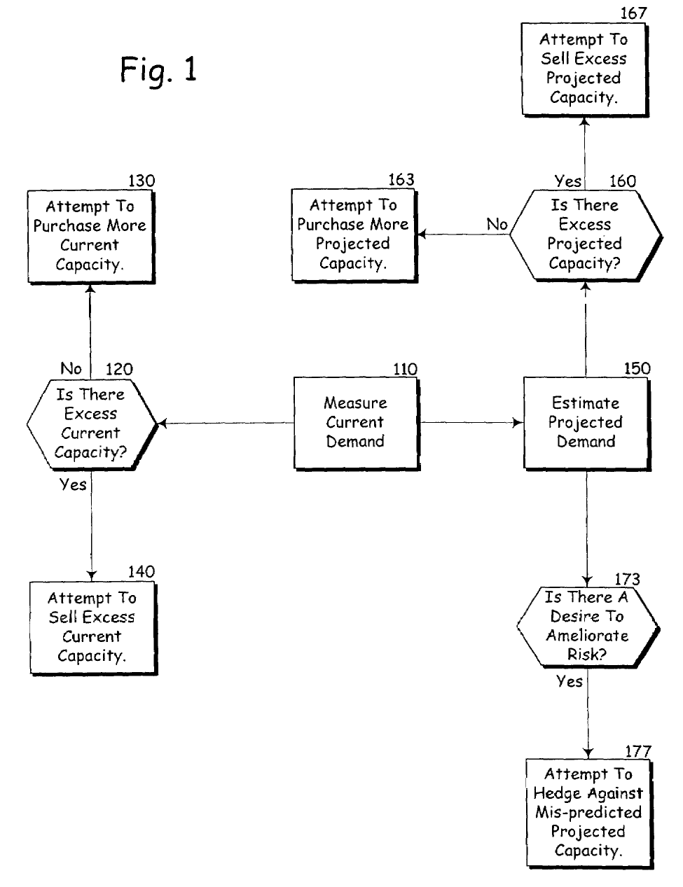

FIG. 1 is a flow chart illustrating an embodiment of a technique to trade computing resources in accordance with the disclosed subject matter. Block 110 illustrates that a company or other person/entity may attempt to measure the current demand for computing resources. It is understood that this measurement may not be entirely accurate.

Block 120 illustrates that a decision may be made as to whether or not there is currently an excess in computing resource capacity. In one embodiment, this may be as simple as determining whether or not current demand exceeds the current level of resource. In other embodiments a “wastage” or other adjusting factor may be used. For example, in one specific embodiment, it may be corporate policy to maintain computing resources at a level 10%, or even 20%, above current demand in other to quickly adjust for unexpected needs. Of course, other techniques for determining excess capacity may be used.

Block 130 illustrates that, if there is insufficient excess capacity an attempt to purchase more current capacity may be made. In one embodiment, this capacity may be purchased utilizing an organized market. In another embodiment, capacity may be bought utilizing a semi-informal one-to-one or multi-party transaction. Another embodiment may involve utilizing a market maker to facilitate or complete the transaction. In yet another embodiment, the transaction may be informal or, conversely, highly formalized. In one embodiment, the transaction may include purchasing capacity for a fixed price, or, in another embodiment, utilizing at least one of a variety of auction techniques.

Block 140 illustrates that, if there is more than sufficient capacity an attempt to sell more current capacity may be made. In one embodiment, this capacity may be sold utilizing an organized market. In another embodiment, capacity may be sold utilizing a semi-informal one-to-one or multi-party transaction. Another embodiment may involve utilizing a market maker to facilitate or complete the transaction. In yet another embodiment, the transaction may be informal or, conversely, highly formalized. In one embodiment, the transaction may include selling capacity for a fixed price, or, in another embodiment, utilizing at least one of a variety of auction techniques.

Block 150 illustrates that an estimate of projected or future demand may be made. In one embodiment, this estimate may be made utilizing, at least in part, the estimated current demand for computing resources.

Block 160 illustrates that a decision may be made as to whether or not there is an excess in projected computing resource capacity. In one embodiment, this may be as simple as determining whether or not projected demand exceeds the projected level of resource. In other embodiments a “wastage” or other adjusting factor may be used. For example, in one specific embodiment, it may be corporate policy to maintain computing resources at a level 10%, or even 20%, above demand in other to quickly adjust for unexpected needs. Of course, other techniques for determining excess capacity may be used.

Block 163 illustrates that an attempt may be made to purchase more capacity for future use. In one embodiment, this capacity may be purchased utilizing an organized market. In another embodiment, capacity may be bought utilizing a semi-informal one-to-one or multi-party transaction. Another embodiment may involve utilizing a market maker to facilitate or complete the transaction. In yet another embodiment, the transaction may be informal or, conversely, highly formalized. In one embodiment, the transaction may include purchasing capacity for a fixed price, or, in another embodiment, utilizing at least one of a variety of auction techniques.

In one embodiment, a contract may be made to purchase computing resources for an agreed-upon price at a fixed future date. These contracts are often referred to as futures contracts. In one embodiment, the contract may specify precise requirements for the computing resources. For example, in a specific embodiment, the contract may specify an architecture, operating system, capability, or other requirement for the computing resources. In one embodiment, the contract may involve computing resources in terms of time, in terms of processing power, processing power as a function of time, or utilize another quantization. In one embodiment, the delivery of the computing resources may be made via a network connection, via a secure connection, or even via physical delivery; it is understood that other delivery techniques are within the scope of the disclosed subject matter. In one embodiment, parties to the transaction must close out their positions at the agreed-upon future date.

In one embodiment, the purchase may be made using a centralized market, where buyers and sellers can trade without personally searching for trading partners. In another embedment, the market may be distributed. In another embodiment, the market may utilize a market marker to facilitate the transactions. In another embodiment, the purchase may be made without utilizing a coordinated market. In one embodiment, the futures contracts, and/or their derivates or related financial instruments may be bought and sold multiple times subsequent to their creation. It is contemplated that, in one embodiment, the two traders that actually fulfill the contract may not be the two traders that originally created the contract. In one embodiment, one or both of the traders may be different. In one embodiment, the trader may not pay the full amount of the contract at the time the contract is made. Instead they may simply pay a good faith (e.g. margin) amount and be expected to pay the balance upon completion of the contract.

In one embodiment, if a trader does not wish to fulfill their obligation under the contract they may purchase a symmetrical contract (i.e. a contract to purchase if the original contract was to sell, and vice versa) to close out the contract. This may effectively transfer the original trader's obligation under the contract to a third party, the third trader involved in the symmetrical contract. In another embodiment, the contract may include provisions to allow withdrawal from the contract. In another embodiment the trader may simply default and risk and legal and commercial repercussions. It is contemplated that other means of existing a contract may exist and are within the scope of the disclosed subject matter.

It is contemplated that the value of the futures contract may vary over time (much as the price for a corporate stock varies over time) as the actual price for computing resources fluctuates. As the actual price for computing resources raises or falls, the price of the future contract may rise and fall in relation. It is contemplated that the rise and fall of the futures contract may not perfectly correlate with the rise and fall in actual computing resource costs. One reason for this may be the forward looking nature of the futures contract. The futures contract specifies a price, not immediately, but in the future at the agreed-upon date. Therefore, the current actual price of the computing resources may be an indicator of the actual price on the expiration date of the futures contract, but it is not the actual price on that date. Therefore, it is contemplated that the price of the futures contract may incorporate the risk associated with the forward-looking nature of the contract.

In another embodiment, the required computing resources may not be purchased out right, but merely an option to purchase the expected computing resources may be made. This may be referred to as a call option. A call option may give the right to purchase computing resources at an agreed upon exercise price at a future agreed-upon date. This may reduce the risk of the purchaser by requiring that a token amount of payment be made instead of a large amount. Furthermore, if the purchase wishes to default on the contract nothing, but the option payment may be lost.

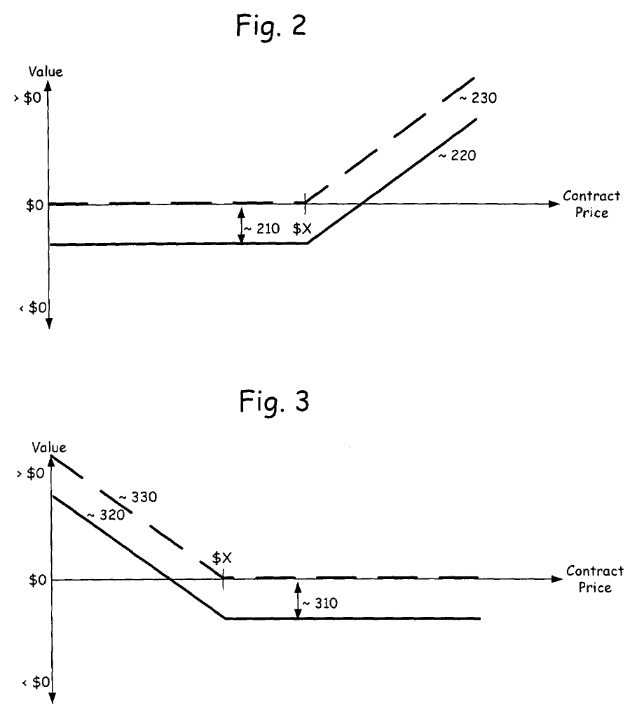

FIG. 2 is a diagram illustrating an embodiment of a technique involving an option to purchase computing resources in accordance with the disclosed subject matter. Line 230 illustrates the value at expiration of a call option. Line 220 illustrates the profit or loss made by the trader by purchasing the call potion. The area 210 illustrates the cost of the option (i.e. the price paid in order to acquire the right to purchase computing resources at an agreed upon exercise price at a future agreed-upon date). A trader may purchase the option with an exercise price (the price the computing resources may be purchased for in the future) of $X.

If at the expiration date (the agreed-upon future date at which the computing resources may be purchased) the prevailing cost to purchase computing resources on the open market (or elsewhere) is less then $X, the trader will typically not exercise the option to purchase the resources. Instead the trader may buy the resources on the open market and not via the option contract. Therefore the value of the call option is considered to be zero. The trader however, does lose whatever they paid for the option initially. This loss is illustrated by the negative value of line 220 for any values below $X.

Conversely, if at the expiration date the prevailing cost to purchase computing resources on the open market (or elsewhere) is more then $X, the trader will typically exercise the option and purchase the resources. Therefore the value of the call option is considered to be more than zero. The option is said to be “in the money”. The trader however, does lose whatever they paid for the option initially. This loss is illustrated by the value of line 220 being below line 230 for any values above $X. In order to actually save money, the difference between the actual cost of computing resources on the open market at the expiration day and the cost of the computing resources under the option must be greater than what the trader paid for the option.

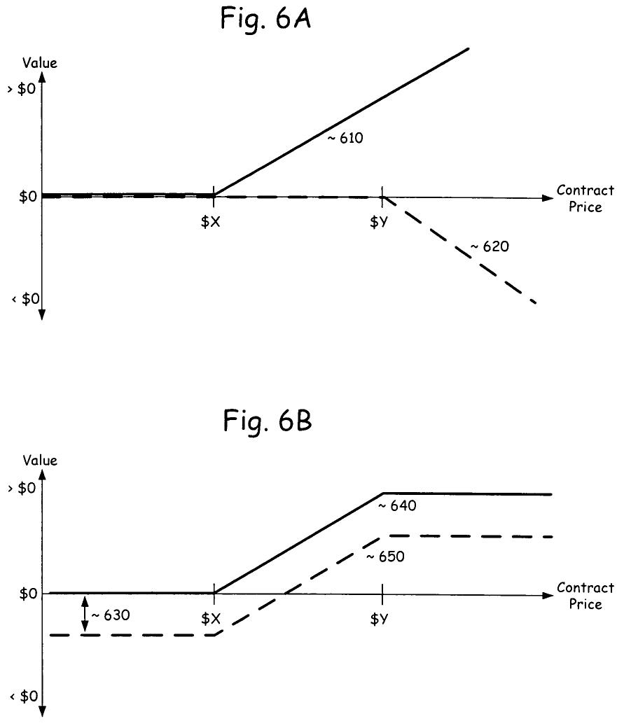

In another embodiment, a call option may be written instead of purchased. This is briefly illustrated by line 620 of FIG. 6A and is essentially the mirror image of the purchased call illustrated by FIG. 2. A written call is when a first trader gives a second trader the right to buy a futures contract from the first trader. When purchasing a call option, the trader in question acts as second trader in the written call scenario. The writing trader is willing incur the risk that the value of the futures contract will increase above the strike price, in order to acquire the purchase price of the call option. Unlike the purchased call illustrated by FIG. 2 where the purchaser pays for the option (illustrated by space 210), the writing trader receives the purchase price as profit.

Block 167 of FIG. 1 illustrates that an attempt may be made to sell excess capacity that is not expected to be needed for future use. In one embodiment, this capacity may be sold utilizing an organized market. In another embodiment, capacity may be sold utilizing a semi-informal one-to-one or multi-party transaction. Another embodiment may involve utilizing a market maker to facilitate or complete the transaction. In yet another embodiment, the transaction may be informal or, conversely, highly formalized. In one embodiment, the transaction may include selling capacity for a fixed price, or, in another embodiment, utilizing at least one of a variety of auction techniques.

In one embodiment, a contract may be made to sell computing resources for an agreed-upon price at a fixed future date. These contracts are often referred to as futures contracts. In one embodiment, the contract may specify precise requirements for the computing resources. For example, in a specific embodiment, the contract may specify an architecture, operating system, capability, or other requirement for the computing resources. In one embodiment, the contract may involve computing resources in terms of time, in terms of processing power, processing power as a function of time, or utilize another quantization. In one embodiment, the delivery of the computing resources may be made via a network connection, via a secure connection, or even via physical delivery; it is understood that other delivery techniques are within the scope of the disclosed subject matter. In one embodiment, parties to the transaction must close out their positions at the agreed-upon future date.

In one embodiment, the sale may be made using a centralized market, where buyers and sellers can trade without personally searching for trading partners. In another embedment, the market may be distributed. In another embodiment, the market may utilize a market marker to facilitate the transactions. In another embodiment, the sale may be made without utilizing a coordinated market. In one embodiment, the trader may not receive the full amount of the contract at the time the contract is made. Instead they may simply receive a good faith (e.g. margin) amount and be expected to receive the balance upon completion of the contract. In one embodiment, the trader may not actually have the contracted computing resources, but may be required to acquire them before the future date.

In one embodiment, if a trader does not wish to fulfill their obligation under the contract they may purchase a symmetrical contract (i.e. a contract to sell if the original contract was to purchase, and vice versa) to close out the contract. This may effectively transfer the original trader's obligation under the contract to a third party, the third trader involved in the symmetrical contract. In another embodiment, the contract may include provisions to allow withdrawal from the contract. In another embodiment the trader may simply default and risk and legal and commercial repercussions. It is contemplated that other means of existing a contract may exist and are within the scope of the disclosed subject matter.

In another embodiment, the required computing resources may not be sold out right, but merely an option to sell the expected computing resources may be made. This may be referred to as a put option. A put option may give the right to sell computing resources at an agreed upon exercise price at a future agreed-upon date. This may reduce the risk of the seller by locking in a future sale price and not be subject to market fluctuations. Furthermore, if the seller wishes to default on the contract nothing, but the option payment may be lost.

FIG. 3 is a diagram illustrating an embodiment of a technique involving an option to sell computing resources in accordance with the disclosed subject matter. Line 330 illustrates the value at expiration of a put option. Line 320 illustrates the profit or loss made by the trader by buying the put option. The area 310 illustrates the cost of the option (i.e. the price gained when the trader sold the right to purchase computing resources at an agreed upon exercise price at a future agreed-upon date). A trader may write the option with an exercise price (the price the computing resources may be purchased for in the future) of $X.

If at the expiration date (the agreed-upon future date at which the computing resources may be purchased) the prevailing selling price for the computing resources on the open market (or elsewhere) is more than $X, the trader will typically not exercise the option to sell the resources. Instead the trader may sell the resources on the open market and not via the option contract. Therefore the value of the put option is considered to be zero. The trader however, does gain whatever they initially sold for the option for. This gain is illustrated by the negative value of line 330 for any values above $X.

Conversely, if at the expiration date the prevailing selling price for the computing resources on the open market (or elsewhere) is less than $X, the trader will typically exercise the option and sell the resources. Therefore the value of the put option is considered to be more than zero. The option is said to be “in the money”. The trader however, does lose whatever they paid for the option initially. This loss is illustrated by the value of line 320 being below line 330 for any values below $X. In order to actually make money, the difference between the actual cost of computing resources on the open market at the expiration day and the cost of the computing resources under the option must be less than what the trader paid for the option.

Block 173 of FIG. 1 illustrates that there may be a desire to ameliorate risk that the estimated projected demand for computing resources may be incorrect. In one embodiment, if there is not desire to ameliorate risk no action need be taken. In another embodiment, a non-illustrated action may be taken; it is understood that such an action is within the scope of the disclosed subject matter.

Block 177 illustrates that, if there is a desire to ameliorate risk that the estimated project demand may be incorrect, an attempt to hedge against the risk may be made. In one embodiment, the call and put options illustrated in FIGS. 2 & 3 and described above may be used. In another embodiment, funds or other financial instruments may be used. In one embodiment, a financial instrument that combines or diversities the computing resources traded may be used. Of course, other techniques to ameliorate the risk may be used and are within the scope of the disclosed subject matter.

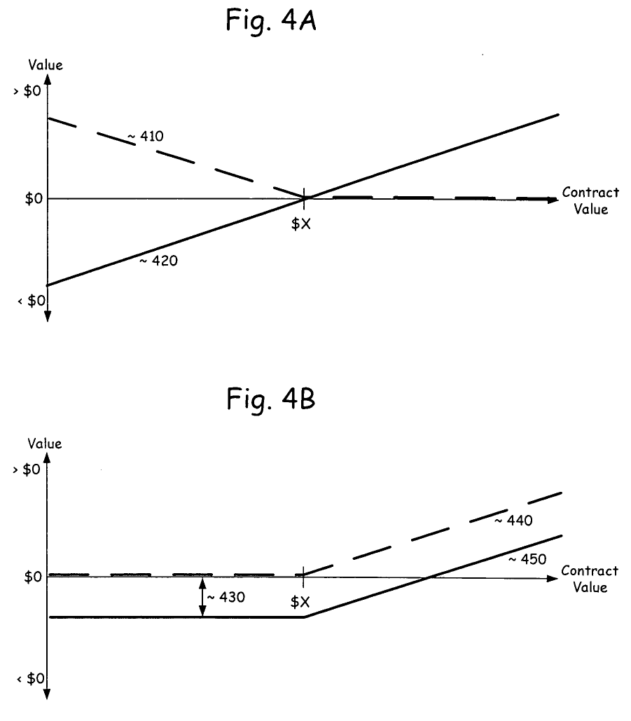

In one embodiment, a protective put, as illustrated by FIGS. 4A & 4B may be used to ameliorate risk. In one illustrative embodiment, a trader may wish to purchase a futures contract for computing resources, but be unwilling to bear potential losses beyond a given level. Investing in a futures contract may be risky. However, this risk may be ameliorated by purchasing a put option that corresponds with the futures contract. Therefore, whatever happens to the futures contract one is guaranteed a payoff equal to the put option's exercise price, because the put option gives the trader the right to sell the computing resources at the option's exercise price regardless of the actual value of the futures contract.

Line 420 illustrates the possible values of the futures contract. Line 410 illustrates the value of the put option. This was described above in reference to FIG. 3. $X is the strike or exercise price of the put option.

Line 440 illustrates the total payoff of the futures contract plus the put option. Notice that the potential losses are limited. Regardless of how bad a deal the futures contract becomes, the value of the put option offsets the loss due to the contract. Conversely, if the futures contract turns out to be a good deal, the put option is not needed and any profit comes from the futures contract. The space 430 illustrates the cost of the put option. It costs something to make the risk of the futures contract go away or be otherwise ameliorated. Therefore, line 450 illustrates the actual profit and loss resulting from the protected put.

In another embodiment, a covered call may be used. A covered call is essentially the mirror image of the protected put (and therefore not illustrated). A covered call may be when a futures contract is purchased along with a corresponding written call. The position is “covered” because the potential obligation to deliver the computing resources (as required by the call option) is covered by the futures contract. The value of the covered call position at the expiration of the call equals the futures contract value minus the value of the call. The total value of the covered call is limited to the strike price of the call option.

Although the trader would forfeit potential profit is from the future contract should its value exceed the strike price of the call option, the covered call may be useful, in one embodiment, as a means to enforce trading discipline. As the maximum profit is limited there will be no incentive to hold futures contracts beyond a certain point. Therefore, in one embodiment, a policy may be put in place to write covered calls to limit the discretion of trader's representatives or employees.

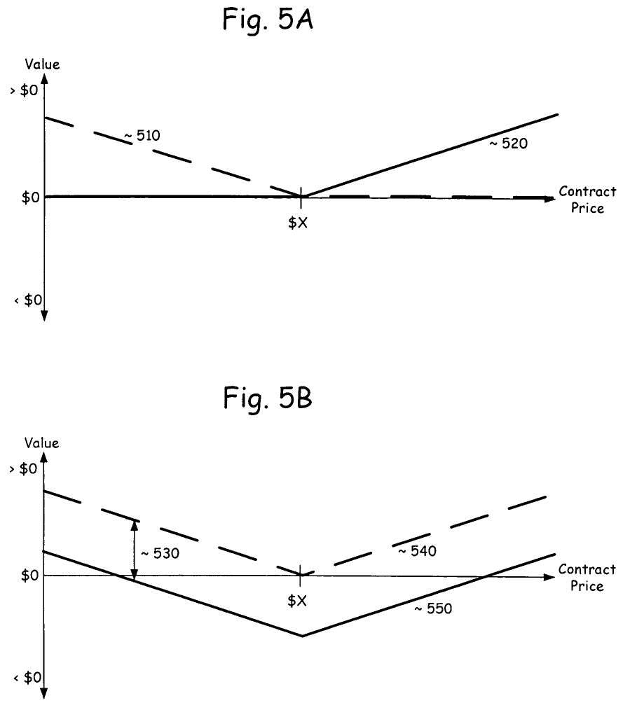

In one embodiment, a straddle, as illustrated by FIGS. 5A & 5B, may be used to ameliorate risk. In one illustrative embodiment, a trader may be concerned that the price for computing resources is volatile and will radically change from a certain price. In one embodiment that price may be a desired price, a current price, or price otherwise determined. However, this risk may be ameliorated by purchasing both a put option and a call option at a certain strike price.

Line 510 illustrates the payoff of the put option in the straddle. Line 520 illustrates the payoff of the call option. Both options have a exercise or strike price of $X. Line 540 illustrates the payoff of the combines straddle. As the price of the underlying futures contract varies from the exercise price of $X one of the options value increases, while the other option is merely driven to a value of zero. Therefore, the more the price of the underlying futures contract diverges from the exercise price the more profit is made. Space 530 reflects the combined cost of the put and the call option. Therefore, the actually realized profit or loss is illustrated by line 550.

In one embodiment, the straddle may be asymmetrical. In one embodiment, the put and call options may have different strike prices. In another embodiment the more put options than call options may be purchased, or vice versa. A put heavy straddle may be referred to as a strip. Conversely a call heavy straddle may be referred to as a strap.

In one embodiment, a collar, as illustrated by FIGS. 6A & 6B, may be used to ameliorate risk. In one illustrative embodiment, a trader may be interested in bracketing their profit or loss between two bounds. In one embodiment, this risk may be accomplished by purchasing both a put option and a call option at a different strike prices, for example $X and $Y.

Line 610 illustrates that a call option may be purchased at a strike price of $X. Line 620 illustrates that a call option may be written for a strike price of $Y. Line 640 illustrates that when combined the purchased and written calls limit the payoff of the collar to between prices of $X and $Y. Space 630 illustrates the cost of the purchased call minus the profit received by writing the other call option. Line 650 illustrates the actual profit realized after taking into account the costs of the options.

In one embodiment, the future contracts and techniques to ameliorate risk may not be used with the actual desire to actually use the computer resources traded, but instead to generate a profit or loss. It is contemplated that financial instruments may be used by those disinterested in the underlying commodities.

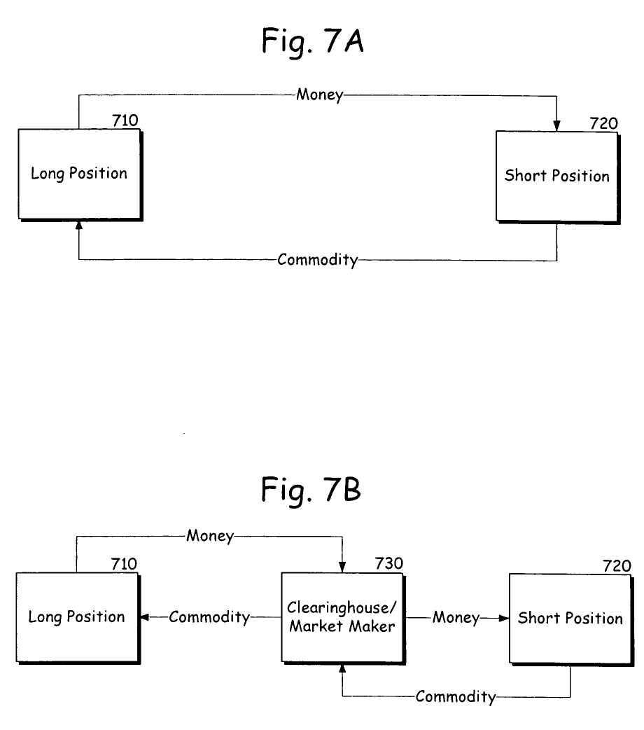

FIGS. 7A & 7B are diagrams illustrating embodiments of techniques to trade computing resources in accordance with the disclosed subject matter. FIG. 7A illustrates an embodiment where the traders directly interact. Block 710 illustrates that one trader may take a long position, in which they buy a commodity, in this case computing resources, in exchange for money. Block 720 illustrates that that a second trader may take a short position, in which they sell a commodity, in this case computing resources, in exchange for money. In one embodiment, these transactions may occur as described above in regards to FIG. 1. Of course it is understood other techniques may be used.

In one embodiment, a more formalized transaction system may be used. FIG. 7B illustrates an embodiment where the traders directly interact utilizing a clearinghouse or market maker. In one embodiment, the individual traders may not directly interact but instead use a third party 730 to complete the transaction. In one embodiment, these transactions may occur as described above in regards to FIG. 1.

In one embodiment, a market maker may be a person or a firm which quotes a buy and sell price in a financial instrument or commodity hoping to make a profit on the turn or the bid/offer spread. In one embodiment an exchange dealing with the trading of computing resources may operate on a matched bargain or order driven basis. In such a system there may be no designated or official market makers but market makers may nevertheless exist. When a buyer's bid meets a seller's offer (or vice versa) the exchange's matching system may decide that a deal has been executed.

In another embodiment, a clearinghouse may be established by an exchange to facilitate the transfer of securities resulting from trades. In one specific embodiment, the clearinghouse may interpose itself as a middleman between traders. While, in another embodiment, the traders may have the option of bypassing the clearinghouse and interact as illustrated in FIG. 7A.

In one embodiment, rather than having traders hold contacts with each other, the clearinghouse becomes the seller of the contract for the long position, and the buyer of the contract for the short position. The clearinghouse may, in one embodiment, be obliged to deliver the computing resources to for the long position, and pay for delivery of the computing resources for the short position. In this embodiment, since the clearinghouse is bound to perform on each side of the contract, it is the only party that can be hurt by a traders' failure to observe its obligations under the futures contract.

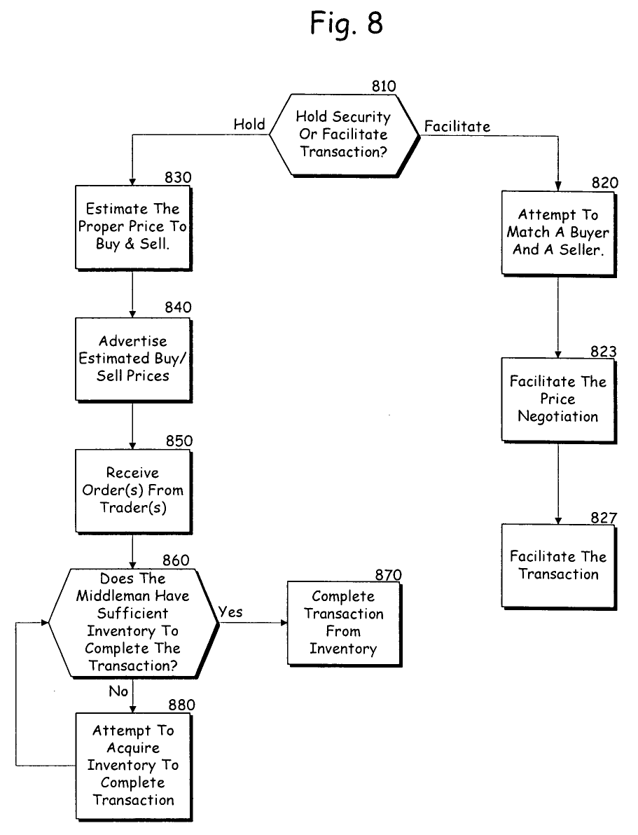

FIG. 8 is a flow chart illustrating an embodiment of a technique to trade computing resources in accordance with the disclosed subject matter. Block 810 illustrates that a market maker, clearinghouse or other middleman or third party involved in the trading of computer resources may make a decision whether to hold securities related to the trading of computer resources, or to merely facilitate the agreement between a buyer and seller of computing resources. In one embodiment, this decision may have been made at the start middleman's business. In another embodiment, the middleman may freely, or occasionally, switch between the two modes of operation. Of course, other techniques to provides services as a middleman are within the scope fo the disclosed subject matter.

Block 820 illustrates an attempt by a middleman to match a buyer and a seller of computing resources. In one embodiment, the middleman may attempt to match the buyer and seller based upon the type and nature of computing resources offered. In one embodiment, the middle man may attempt to match an individual, small group, or even a large group of individuals together to facilitate a transaction. For example, it may not be possible to match buyers and sellers on a one-to-one basis. It may only be possible to meet the needs of the buyers and sellers by combining the offers and needs of multiple participants. In one embodiment, this may involve the writing of a single group contract, or in another embodiment, the writing of several individual contracts.

Block 823 illustrates that, in one embodiment, the middleman may facilitate the price negotiation between the buyer and the seller. It is contemplated that this negotiation may include an auction, or other techniques.

Block 827 illustrates that, in one embodiment, the middleman may facilitate completing the transaction between the buyer and seller. In one embodiment, this may include a situation as illustrated by FIG. 7B. In another embodiment, the middleman may simply coordinate the transfer of funds and any documentation relating to the transaction.

Blocks 830, 840, 850, 860, 870, & 880 illustrate that, in one embodiment, the middleman has selected to hold an inventory of securities. It is contemplated that this inventory may be held for any length of time. In one embodiment, the inventory may be held a matter of seconds, essentially getting rid of the inventory instantaneously. Conversely in another embodiment, the inventory may be held indefinitely as securities are rotated through the inventory.

Block 830 illustrates that in one embodiment, the middleman may estimate the proper price to buy or sell a selected security. In one embodiment, this may be based at least in part upon the price other middlemen are charging for the security. In another embodiment, the estimated price may be based at least in part by the amount of a security being offered for sale, the amount of a security sought for purchase, the price asked by the originators of a security for the sale of that security, or a combination thereof. Of course, other techniques may be used and are within the scope of the disclosed subject matter.

Block 840 illustrates that in one embodiment, the estimated price may be advertised. In one embodiment, this advertisement may be via an electronic means. In one embodiment this advertisement may take the form of a communication to an exchange. In one embodiment, the exchange may take price estimates from a number of middlemen and generate a composite price for the exchange. Of course, other techniques may be used and are within the scope of the disclosed subject matter.

Block 850 illustrates that, in one embodiment, the middleman may receive orders from traders. In one embodiment the orders may be merely offers. In one embodiment, the order may involve an agent of the trader as opposed to the trader personally. In one embodiment, the order may be received electronically. In another embodiment, the order may be received in person. In one embodiment, the orders may be received in an orderly fashion, such as, for example, a first come, first served basis. In another embodiment, the order may be received in a chaotic fashion, such as, for example, a group of people yelling to make a trade. Of course, other techniques may be used and are within the scope of the disclosed subject matter.

Block 860 illustrated that, in one embodiment, the middleman may determine whether or not they have sufficient inventory to complete the transaction. Block 870 illustrates that, in one embodiment, if the middleman ahs sufficient inventory the transaction may be completed from that inventory. In one embodiment, the middleman may act as a clearinghouse and assume the obligation of each side of the transaction. In another embodiment, the middleman may act as a marker maker, and leave the traders taking the short and long positions with their respective obligations to each other. Of course, other techniques may be used and are within the scope of the disclosed subject matter.

Block 880 illustrated that, in one embodiment, the middleman may attempt to acquire the needed inventory to complete the desired transaction. In one embodiment, the inventory may be acquired from another middleman. In another embodiment the inventory may be acquired from various traders. In one embodiment, only the necessary inventory may be acquired. Conversely, in another embodiment, a level of inventory may be acquired beyond that needed for the immediate transaction. In one embodiment the immediate transaction may be delayed to facilitate the middleman acquiring sufficient inventory to complete the trade. Of course, other techniques may be used and are within the scope of the disclosed subject matter.

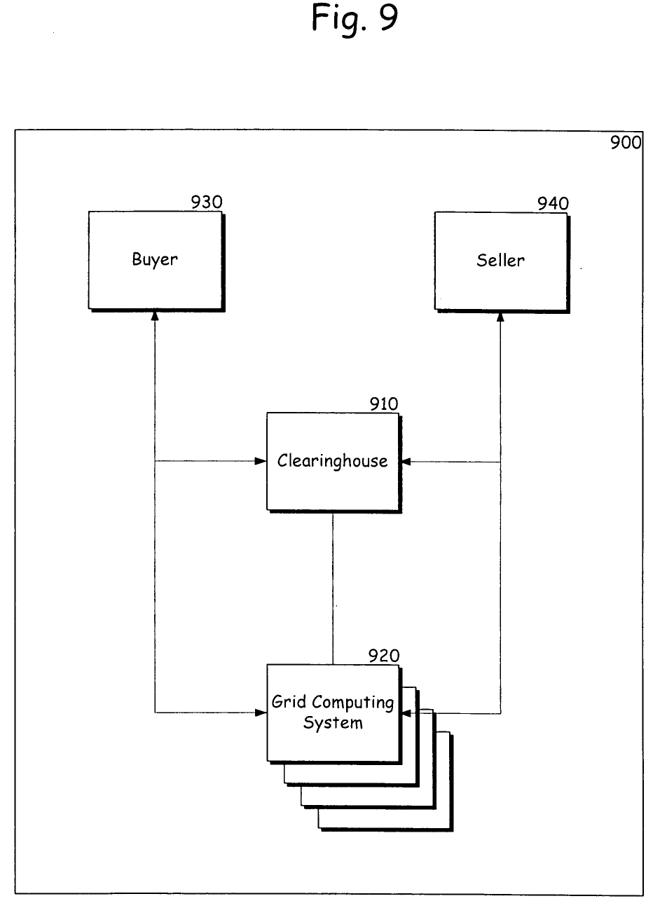

FIG. 9 is a block diagram illustrating an embodiment of a system 900 to trade computing resources in accordance with the disclosed subject matter. In one embodiment, the exchange for trading computer resources may include a buyer 930, a seller 940, and at least one computing system 920. In one embodiment, the computing system may be a grid computing system. In another embodiment, the system may also include a middleman 910. In a specific embodiment, the middleman may be a clearinghouse.

In one embodiment, the utilization of the computing system 920 may be capable of being bought and sold. In one embodiment, the utilization may be bought and sold as discussed regarding FIG. 1 and described above; however, other techniques are within the scope of the disclosed subject matter.

In one embodiment, the buyer 930 and the seller 940 may be cable of purchasing or selling the utilization of the computing system 920. In one embodiment, the buyer and seller may be capable of utilizing the technique illustrated by FIG. 1 and subsequent figures and described above; however, other techniques are within the scope of the disclosed subject matter. In one embodiment, the system 900 may include a plurality of buyers and sellers. In one embodiment, the system may include only a single buyer, a middleman 910, and not seller (or a seller and no buyer). In this embodiment, the middleman 910 may act as the seller.

In one embodiment, the middleman 910 may be capable of making a market for the utilization of the computing system 920. In one embodiment, the middleman may utilize the techniques illustrated by FIG. 8 and described above; however, other techniques are within the scope of the disclosed subject matter. In one embodiment, the middleman may act as a clearinghouse. In another embodiment, the middleman may act as a market maker.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

The following is claimed:

1. A method comprising:
facilitating the transfer of a security related to the utilization of at least one grid computing system.

2. The method of claim 1, wherein facilitating the transfer the security includes:
interposing oneself as a middleman between a plurality of traders.

3. The method of claim 1, wherein facilitating the transfer the security includes:
estimating a price to transfer the security;
advertising the estimated price; and
receiving an order from a plurality of traders.

4. The method of claim 3, wherein facilitating the transfer the security includes:
determining if the middleman has sufficient inventory to complete the received orders;
if so, attempting to complete the transfer of the security between the traders.

5. The method of claim 4, wherein determining if the middleman has sufficient inventory to complete the received orders includes:
determining the difference between the number of securities offered for sale by a first trader and the number of securities offered for purchase by a second trader; and
determining if the middleman has sufficient inventory to ameliorate any deficiency between the sale and purchase offers.

6. The method of claim 3, wherein
if the middleman does not have sufficient inventory to complete the received orders, attempting to acquire sufficient inventory to complete the received orders.

7. The method of claim 1, wherein facilitating the transfer the security includes:
facilitating the matching of a buying trader with a selling trader; and
facilitating the transfer of the security between the buying and the selling traders.

8. The method of claim 7, wherein facilitating the transfer of the security between the buying and the selling traders includes:
purchasing the security from the selling trader; and
selling the security to the buying trader.

9. The method of claim 8, the middleman is contractually obligated to perform both the selling and buying side of the security.

10. A method comprising:
participating in a market that facilitates the transfer of a security related to the utilization of at least one grid computing system.

11. The method of claim 10, wherein participating includes:
estimating a projected demand for computing resources;
comparing the projected demand to a projected capacity for computing resources;
attempting to buy the utilization of computing resources to ameliorate a deficiency between the projected demand and the projected capacity.

12. The method of claim 11, wherein participating further includes:
attempting to sell the utilization of computing resources to utilize an excess between the projected demand and the projected capacity.

13. The method of claim 10, wherein the transfer of a security related to the utilization of at least one grid computing system is a futures contract related to the utilization of at least one grid computing system.

14. The method of claim 10, wherein the transfer of a security related to the utilization of at least one grid computing system is an option on a futures contract related to the utilization of at least one grid computing system.

15. The method of claim 14, wherein participating includes attempting to ameliorate risk due to mispredicting a projected demand for computing resources.

16. The method of claim 15, wherein attempting to ameliorate risk includes the utilization of at least one financial instrument selected from the following group consisting of:
a put option associated with computing resources;
a put option associated with a futures contract for computing resources;
a call option associated with computing resources;
a call option associated with a futures contract for computing resources;
a collar associated with computing resources;
a covered call associated with computing resources; and
a protective put associated with computing resources.

17. The method of claim 14, wherein participating includes attempting to make a speculative profit based upon demand for computing resources.

18. The method of claim 17, wherein attempting to make a speculative profit includes the utilization of at least one financial instrument selected from the following group consisting of:
a put option associated with computing resources;
a put option associated with a futures contract for computing resources;
a call option associated with computing resources;
a call option associated with a futures contract for computing resources;
a straddle associated with computing resources;
a spread associated with computing resources; and
a protective put associated with computing resources.

19. The method of claim 10, wherein participating includes:
attempting to determine a current demand for computing resources;
attempting to determine a current capacity of computing resources;
if the current demand exceeds the current capacity, attempting to purchase the utilization of more computing resources; and
if the current capacity exceeds the current demand, attempting to sell the utilization of the excess computing resources.

20. The method of claim 10, wherein participating includes utilizing a middleman to facilitate the transfer of a security related to the utilization of at least one grid computing system.

21. An article comprising:
a machine accessible medium having a plurality of machine accessible instructions,
wherein when the instructions are executed, the instructions provide for:
facilitating the transfer of a security related to the utilization of at least one grid computing system.

22. An article comprising:
a machine accessible medium having a plurality of machine accessible instructions,
wherein when the instructions are executed, the instructions provide for:
participating in a market that facilitates the transfer of a security related to the utilization of at least one grid computing system.

23. A system comprising:
a buying trader, capable of purchasing a security related to the utilization of at least one grid computing system;
a selling trader, capable of purchasing a security related to the utilization of at least one grid computing system; and
at least one grid computing system, wherein at least a portion of the utilization of the at least one grid computing system is capable of being bought and sold.

24. The system of claim 23, wherein the security related to the utilization of at least one grid computing system is a futures contract related to the utilization of at least one grid computing system.

25. The system of claim 23, wherein the security related to the utilization of at least one grid computing system is an option on a futures contract related to the utilization of at least one grid computing system.

26. The system of claim 23, wherein the buying trader is capable of:
estimating a projected demand for computing resources;
comparing the projected demand to a projected capacity for computing resources;
attempting to buy the utilization of computing resources to ameliorate a deficiency between the projected demand and the projected capacity.

27. The system of claim 26, wherein the buying trader is capable of:
attempting to determine a current demand for computing resources;
attempting to determine a current capacity of computing resources;
if the current demand exceeds the current capacity, attempting to purchase the utilization of more computing resources; and
if the current capacity exceeds the current demand, attempting to sell the utilization of the excess computing resources.

28. The system of claim 23, further comprising:
a middleman, capable of facilitating the transfer of a security related to the utilization of the at least one grid computing system.

29. The system of claim 28, wherein the middleman is further capable of:
estimating a price to transfer the security;
advertising the estimated price; and
receiving an order from a plurality of traders.

30. The system of claim 28, wherein the middleman is further capable of:
facilitating the matching of the buying trader with the selling trader, and
facilitating the transfer of the security between the buying and the selling traders; and
wherein facilitating the transfer of the security includes:
purchasing the security from the selling trader, and
selling the security to the buying trader.
